(19) United States
(12) Patent Application Publication
(10) Pub. No.: US 2025/0301251 A1
(43) Pub. Date: Sep. 25, 2025

(54) HEARING DEVICE AND A METHOD OF ADJUSTING A SIDETONE GAIN IN A HEARING DEVICE

(71) Applicant: GN Audio A/S, Ballerup (DK)

(72) Inventors: Henrik Gert HASSAGER, Ballerup (DK); Jesper UDESEN, Ballerup (DK); Mark Crispin Sandholt DOURADO, Ballerup (DK)

(21) Appl. No.: 19/088,193

(22) Filed: Mar. 24, 2025

(30) Foreign Application Priority Data
Mar. 25, 2024 (EP) 24165764.2

(51) Int. Cl. H04R 1/10

(52) U.S. Cl. CPC H04R 1/1041; H04R 2201/107; H04R 2430/01

(57) ABSTRACT

Disclosed is a hearing device configured to adjust a sidetone gain. The hearing device comprises an input transducer, a transceiver, a processing unit and an output transducer. The processing unit comprises a first component arranged in connection with the input transducer and the transceiver and configured to process the input signals to obtain processed input signals, a second component configured to receive the processed input signals and to apply a model to the processed input signals to determine a sidetone parameter, and a third component configured to adjust a sidetone gain of the first part of the input signal, based on the sidetone parameter, to obtain the output signal having the adjusted sidetone gain.

### FIELD

The present invention relates to hearing devices. More specifically, the disclosure relates to a hearing device configured to adjust a sidetone gain and a method of adjusting a sidetone gain in a hearing device.

### BACKGROUND

Sidetone is the acoustic feedback of one's own voice that may be heard through a communication device, such as a hearing device. Sidetone can assist a user of such hearing device to adjust their speaking volume and to confirm that the hearing device is working properly. Sidetone is also beneficial for people who are hearing impaired, as it helps them to have a more natural and comfortable conversation. Absence of the sidetone can cause users to speak loudly and too much sidetone can cause the users to speak softly.

Over the past years, the hearing devices have been developed and attempts have been made to assist the users of such hearing devices to adjust their speaking volume when using such hearing devices. For instance, models have been developed to assist the users such as ISO 532-1: 2017 (E) Acoustics-Methods for calculating loudness-Part 1: Zwicker method and ISO 532-2: 2017 (E) Acoustics-Methods for calculating loudness-Part 2: Moore-Glasberg method. However, there is still a need for an improved hearing device which allows for adjusting the sidetone in an improved manner as well as an improved method of adjusting the sidetone by such hearing device.

### SUMMARY

According to a first aspect of the invention, a hearing device is disclosed. The hearing device is configured to adjust a sidetone gain. The hearing device comprises an input transducer. The input transducer is configured to receive an input sound and to convert the input sound into an input signal. The hearing device comprises a transceiver. The transceiver is configured to receive another input sound and to convert the another input sound into another input signal. The hearing device comprises a processing unit. The processing unit is arranged in connection with the input transducer and the transceiver. The processing unit is configured to receive the input signal from the input transducer and the another input signal from the transceiver. The processing unit is configured to provide an output signal having an adjusted sidetone gain. The hearing device comprises an output transducer. The output transducer is arranged in connection with the processing unit. The output transducer is configured to receive the output signal from the processing unit and to convert the output signal into an output sound. The processing unit comprises a first component. The first component is arranged in connection with the input transducer and the transceiver. The first component is configured to receive the input signals and to process the input signals to obtain processed input signals. The processing unit comprises a second component. The second component is arranged in connection with the first component. The second component is configured to receive the processed input signals and to apply a model to the processed input signals to determine a sidetone parameter. The processing unit comprises a third component. The third component is arranged in connection with the second component. The third component is configured to receive the sidetone parameter from the second component and a first part of the input signal, corresponding to a user's voice, from the input transducer. The third component is configured to adjust a sidetone gain of the first part of the input signal based on the sidetone parameter to obtain the output signal having the adjusted sidetone gain.

The hearing device may be configured to be worn by a user. The hearing device may be any type of hearing devices such as a headset. The hearing device may be configured to be worn at a user's head. For instance, the headset may comprise a headband configured to be worn at the user's head. The headset may comprise at least one earphone. The earphone may be configured to be worn at/on/over/in a user's ear. The headset may comprise two earphones. The user may wear the two earphones, one at/on/over/in each ear. The earphone may be any types of earphones. The hearing device may be any other type of hearing device such as an earbud, a hearing aid, or another head-wearable hearing device.

The input transducer allows for receiving the input sound. The input transducer may be a receiver or a microphone. The input transducer may comprise a plurality of input transducers such as a boom arm microphone and a hearing device microphone. The boom arm microphone may be arranged at the boom arm of the hearing device. The hearing device microphone may be arranged in the hearing device i.e. not at the boom arm. For instance, the hearing device microphone may be arranged inside the hearing device e.g. in/at/on one of the earphones.

The input sound may comprise the user's voice and a sound from the user's background. The background sound may e.g. correspond to a noisy environment, a music being played in the background, ambient noise and unwanted sound. In the case that the hearing device comprises a boom arm microphone, the boom arm microphone may be configured to receive the user's voice. The boom arm microphone may also be configured to receive sound from the user's background.

The another input sound may comprise a far-end voice and sound. By the term far-end voice and sound is hereby referred to the voice and the sound that are being transmitted from the other end of a communication link to the hearing device which are being received by the hearing device. The far-end voice and sound may be heard by the user of the hearing device when the user is wearing the hearing device at its intended position. An example of the far-end voice is voices of participants of a conference call, who are not physically present in the same room as the user of the hearing device i.e. the voices of such participants are transmitted over a communication link to hearing device and received by the hearing device in which the user is wearing. Examples of the far-end sound are an acoustic echo sound, sound corresponding to a noisy environment in the far-end background, a music being played in the far-end background, far-end ambient noise and far-end unwanted sound.

The transceiver may be configured to receive the far-end signal corresponding to the far-end voice and sound, either wirelessly or by a wired connection, e.g. in the form of a RF signal (Bluetooth, DECT etc.) or an electrical signal.

The output transducer allows for converting the output signal into the output sound. The output transducer may be a receiver or a speaker. The output transducer may deliver/transmit/pass the output sound into a user's ear.

The first component allows for processing the input signals. The first component may process the input signals by de-reverberation and de-noising of the input signals. The first component may process the input signals using a mathematical function e.g. a transfer function to estimate sound pressure at a user's eardrum when the user is not wearing the hearing device.

The transfer function may be selected based on the input transducer. For example, if the input transducer is a boom arm microphone, the transfer function may be a mouth-to-ear transfer function. Another example, if the input transducer is a hearing device microphone, the transfer function may be a hearing device-to-ear transfer function.

The second component allows for applying the model to the processed input signals to determine a sidetone parameter. The model may be a peripheral auditory model which may allow for mimicking spectral and temporal masking performed by the human auditory system.

The spectral masking may be called simultaneous masking or frequency masking. The temporal masking may be divided into two types of pre-masking or backward masking and post-masking or forward masking. In the pre-masking, a sound (the maskee) may be less audible because of a following sound (the masker). In post-masking, the perception of a sound (the maskee) may be masked by a preceding sound (the masker). The model may be a loudness model. The loudness model may determine a loudness ratio. The loudness model may classify/categorize the processed input signals into different categories. The auditory loudness model may quantify the perceived loudness in a way that mimics how humans perceive the loudness or level of sounds and the loudness ratio may be a comparative difference in perceived loudness between two sounds.

The third component allows for adjusting the sidetone gain of the first part of the input signal, corresponding to the user's voice, based on the sidetone parameter to obtain the output signal having the adjusted sidetone gain. The adjusting of the sidetone gain may comprise increasing the sidetone gain. The adjusting of the sidetone may comprise decreasing the sidetone gain. The adjusting the sidetone gain may comprise no change of the sidetone gain, in the case the sidetone gain is not high or low i.e. the sidetone gain has a suitable value.

It is an advantage that the hearing device comprises the processing unit that is configured to provide the output signal having the adjusted sidetone gain. Thereby, hearing device allows for the user of the hearing device to speak at a normal level i.e. not too loud and not too soft. In addition, the hearing device allows for the user to communicate effectively without disturbing other people around him e.g. when the user of the hearing device is having a meeting in an open space area.

It is another advantage that the hearing device allows for automatically providing the output signal having the adjusted sidetone gain. In another word, it is another advantage that the hearing device comprises the processing unit that is configured to automatically provide the output signal having the adjusted sidetone gain. Hence, the user does not need to adjust a sidetone level e.g. by adjusting a knob. Thus, the inventive concept of the present invention allows for a simple, convenient and user-friendly hearing device that does not require the user's interaction for adjusting the sidetone gain.

In an embodiment, a hearing device is configured to be worn by a user. The hearing device may be arranged at the user's ear, on the user's ear, over the user's ear, in the user's ear, in the user's ear canal, behind the user's ear and/or in the user's concha, i.e., the hearing device is configured to be worn in, on, over and/or at the user's ear. The user may wear two hearing devices, one hearing device at each ear. The two hearing devices may be connected, such as wirelessly connected and/or connected by wires, such as a binaural hearing aid system.

The hearing device may be a hearable such as a headset, headphone, earphone, earbud, hearing aid, a personal sound amplification product (PSAP), an over-the-counter (OTC) hearing device, a hearing protection device, a one-size-fits-all hearing device, a custom hearing device or another head-wearable hearing device. Hearing devices can include both prescription devices and non-prescription devices.

The hearing device may be embodied in various housing styles or form factors. Some of these form factors are Behind-the-Ear (BTE) hearing device, Receiver-in-Canal (RIC) hearing device, Receiver-in-Ear (RIE) hearing device or Microphone-and-Receiver-in-Ear (MaRIE) hearing device. These devices may comprise a BTE unit configured to be worn behind the ear of the user and an in the ear (ITE) unit configured to be inserted partly or fully into the user's ear canal. Generally, the BTE unit may comprise at least one input transducer, a power source and a processing unit. The term BTE hearing device refers to a hearing device where the receiver, i.e. the output transducer, is comprised in the BTE unit and sound is guided to the ITE unit via a sound tube connecting the BTE and ITE units, whereas the terms RIE, RIC and MaRIE hearing devices refer to hearing devices where the receiver may be comprised in the ITE unit, which is coupled to the BTE unit via a connector cable or wire configured for transferring electric signals between the BTE and ITE units.

Some of these form factors are In-the-Ear (ITE) hearing device, Completely-in-Canal (CIC) hearing device or Invisible-in-Canal (IIC) hearing device. These hearing devices may comprise an ITE unit, wherein the ITE unit may comprise at least one input transducer, a power source, a processing unit and an output transducer. These form factors may be custom devices, meaning that the ITE unit may comprise a housing having a shell made from a hard material, such as a hard polymer or metal, or a soft material such as a rubber-like polymer, molded to have an outer shape conforming to the shape of the specific user's ear canal.

Some of these form factors are earbuds, on the ear headphones or over the ear headphones. The person skilled in the art is well aware of different kinds of hearing devices and of different options for arranging the hearing device in, on, over and/or at the ear of the hearing device wearer. The hearing device (or pair of hearing devices) may be custom fitted, standard fitted, open fitted and/or occlusive fitted.

In an embodiment, the hearing device may comprise one or more input transducers. The one or more input transducers may comprise one or more microphones. The one or more input transducers may comprise one or more vibration sensors configured for detecting bone vibration. The one or more input transducer(s) may be configured for converting an acoustic signal into a first electric input signal. The first electric input signal may be an analogue signal. The first electric input signal may be a digital signal. The one or more input transducer(s) may be coupled to one or more analogue-to-digital converter(s) configured for converting the analogue first input signal into a digital first input signal.

In an embodiment, the hearing device may comprise one or more antenna(s) configured for wireless communication. The one or more antenna(s) may comprise an electric antenna. The electric antenna may be configured for wireless communication at a first frequency. The first frequency may be above 800 MHZ, preferably a wavelength between 900 MHz and 6 GHz. The first frequency may be 902 MHz to 928 MHz. The first frequency may be 2.4 to 2.5 GHz. The first frequency may be 5.725 GHz to 5.875 GHz. The one or more antenna(s) may comprise a magnetic antenna. The magnetic antenna may comprise a magnetic core. The magnetic antenna may comprise a coil. The coil may be coiled around the magnetic core. The magnetic antenna may be configured for wireless communication at a second frequency. The second frequency may be below 100 MHz. The second frequency may be between 9 MHz and 15 MHz.

In an embodiment, the hearing device may comprise one or more wireless communication unit(s). The one or more wireless communication unit(s) may comprise one or more wireless receiver(s), one or more wireless transmitter(s), one or more transmitter-receiver pair(s) and/or one or more transceiver(s). At least one of the one or more wireless communication unit(s) may be coupled to the one or more antenna(s). The wireless communication unit may be configured for converting a wireless signal received by at least one of the one or more antenna(s) into a second electric input signal. The hearing device may be configured for wired/wireless audio communication, e.g. enabling the user to listen to media, such as music or radio and/or enabling the user to perform phone calls.

In an embodiment, the wireless signal may originate from one or more external source(s) and/or external devices, such as spouse microphone device(s), wireless audio transmitter(s), smart computer(s) and/or distributed microphone array(s) associated with a wireless transmitter. The wireless input signal(s) may origin from another hearing device, e.g., as part of a binaural hearing system and/or from one or more accessory device(s), such as a smartphone and/or a smart watch.

In an embodiment, the hearing device may include a processing unit. The processing unit may be configured for processing the first and/or second electric input signal(s). The processing may comprise compensating for a hearing loss of the user, i.e., apply frequency dependent gain to input signals in accordance with the user's frequency dependent hearing impairment. The processing may comprise performing feedback cancelation, beamforming, tinnitus reduction/masking, noise reduction, noise cancellation, speech recognition, bass adjustment, treble adjustment and/or processing of user input. The processing unit may be a processor, an integrated circuit, an application, functional module, etc. The processing unit may be implemented in a signal-processing chip or a printed circuit board (PCB). The processing unit may be configured to provide a first electric output signal based on the processing of the first and/or second electric input signal(s). The processing unit may be configured to provide a second electric output signal. The second electric output signal may be based on the processing of the first and/or second electric input signal(s).

In an embodiment, the hearing device may comprise an output transducer. The output transducer may be coupled to the processing unit. The output transducer may be a receiver. It is noted that in this context, a receiver may be a loudspeaker, whereas a wireless receiver may be a device configured for processing a wireless signal. The receiver may be configured for converting the first electric output signal into an acoustic output signal. The output transducer may be coupled to the processing unit via the magnetic antenna. The output transducer may be comprised in an ITE unit or in an earpiece, e.g. Receiver-in-Ear (RIE) unit or Microphone-and-Receiver-in-Ear (MaRIE) unit, of the hearing device. One or more of the input transducer(s) may be comprised in an ITE unit or in an earpiece.

In an embodiment, the wireless communication unit may be configured for converting the second electric output signal into a wireless output signal. The wireless output signal may comprise synchronization data. The wireless communication unit may be configured for transmitting the wireless output signal via at least one of the one or more antennas.

In an embodiment, the hearing device may comprise a digital-to-analogue converter configured to convert the first electric output signal, the second electric output signal and/or the wireless output signal into an analogue signal.

In an embodiment, the hearing device may comprise a vent. A vent is a physical passageway such as a canal or tube primarily placed to offer pressure equalization across a housing placed in the ear such as an ITE hearing device, an ITE unit of a BTE hearing device, a CIC hearing device, a RIE hearing device, a RIC hearing device, a MaRIE hearing device or a dome tip/earmold. The vent may be a pressure vent with a small cross section area, which is preferably acoustically sealed. The vent may be an acoustic vent configured for occlusion cancellation. The vent may be an active vent enabling opening or closing of the vent during use of the hearing device. The active vent may comprise a valve.

In an embodiment, the hearing device may comprise a power source. The power source may comprise a battery providing a first voltage. The battery may be a rechargeable battery. The battery may be a replaceable battery. The power source may comprise a power management unit. The power management unit may be configured to convert the first voltage into a second voltage. The power source may comprise a charging coil. The charging coil may be provided by the magnetic antenna.

In an embodiment, the hearing device may comprise a memory, including volatile and non-volatile forms of memory.

In some embodiments, the input transducer comprises a first input transducer. The first input transducer may be configured to receive a first part of the input sound. The first input transducer may be configured to convert the first part of the input sound into the first part of the input signal. In some embodiments, the input transducer comprises a second input transducer. The second input transducer may be configured to receive a second part of the input sound. The second input transducer may be configured to convert the second part of the input sound into a second part of the input signal. The processing unit may be configured to receive the first part of the input signal from the first input transducer, the second part of the input signal from the second input transducer, and the another input signal from the transceiver. The processing unit may be configured to provide the output signal having the adjusted sidetone gain.

The first input transducer may be a boom arm microphone. The first part of the input sound may correspond to the user's voice. The second input transducer may be a hearing device microphone. The second part of the input sound may correspond to the user's background sound. The first input transducer may be arranged at a first distance from the user's ear. The second input transducer may be arranged at a second distance from the user's ear. The first distance and the second distance may be different e.g. the first input transducer sits closer to the user's mouth than the second input transducer. The first part of the input sound and the second part of the input sound may be obtained in a manner which per se is known in the art (e.g. using spatial filtering e.g. beamforming) based on the first input transducer and the second input transducer. The processing unit, the first input transducer and the second input transducer may form a directional microphone system. Different spatial filtering techniques including beamformers are known in the art to e.g. extract a speaker's voice e.g. a user's own voice. As examples, the minimum variance distortionless response (MVDR) beamformer is widely used in microphone signal processing. Ideally the MVDR beamformer keeps signals from a target direction unchanged, while attenuating sound signals from other directions maximally. The generalized sidelobe canceller (GSC) structure is an equivalent representation of the MVDR beamformer offering computational and numerical advantages over a direct implementation in its original form. An MVDR beamformer is described in more detail e.g. in EP 3422736 B1 e.g. [0044-0060], and U.S. Pat. No. 10,225,674 B2 which are incorporated herein as specific examples of spatial filtering to extract a user's own voice. The first component may be configured to process the first part of the input signal, based on the first distance. The first component may be configured to process the second part of the input signal, based on the second distance to obtain the processed input signals. By the term “part” is hereby referred to as a region/portion/segment of the input sound in a time domain, a frequency domain or any other domains.

In some embodiments, the first component comprises a first sub-component. The first sub-component may be arranged in connection with the first input transducer. The first sub-component may be configured to improve the first part of the input signal. The third component may be configured to receive the improved first part of the input signal. The third component may be configured to adjust the sidetone gain of the improved first part of the input signal, based on the sidetone parameter, to obtain the output signal having the adjusted sidetone gain.

The first sub-component may be configured to improve the first part of the input signal by processing the first part of the input signal e.g. by de-reverberation and de-noising of the first part of the input signal. The first sub-component may allow for obtaining an improved first part of the input signal e.g. a cleaner first part of the input signal without or at least with less noise. Thereby, the first sub-component may allow for providing an improved output signal having the adjusted sidetone gain e.g. an improved output signal with an improved signal to noise ratio (SNR).

According to a second aspect of the invention, a method of adjusting a sidetone gain in a hearing device is provided. The method comprises the step of receiving an input sound by an input transducer of the hearing device and another input sound by a transceiver of the hearing device. The method further comprises the step of converting the input sound into an input signal by the input transducer of the hearing device and the another input sound into another input signal by the transceiver of the hearing device. The method further comprises the step of processing the input signals by a first component of a processing unit of the hearing device to obtain processed input signals. The method further comprises the step of applying a model to the processed input signals by a second component of the processing unit of the hearing device to determine a sidetone parameter. The method further comprises the step of adjusting a sidetone gain of a first part of the input signal, based on the sidetone parameter, by a third component of the processing unit of the hearing device to obtain an output signal having an adjusted sidetone gain. The method further comprises the step of outputting the output signal to an output transducer of the hearing device.

This aspect of the invention may generally present the same or corresponding advantages, as defined above in accordance with the first aspect of the invention. The step of receiving the input sound by the input transducer of the hearing device may comprise receiving a first part of the input sound by a first input transducer of the hearing device and receiving a second part of the input sound by a second input transducer of the hearing device.

In some embodiments, the step of converting the input sound into the input signal and the another input sound into another input signal comprises converting a part of the input signal corresponding to a user's voice into a first part of the input signal. In some embodiments, the step of converting the input sound into the input signal and the another input sound into another input signal comprises converting a part of the input signal corresponding to a background sound into a second part of the input signal. In some embodiments, the step of converting the input sound into the input signal and the another input sound into another input signal comprises converting a part of the another input signal corresponding to a far-end voice into a third part of the input signal.

The step of converting the input sound into the input signal and the another input sound into another input signal may be performed in a manner which per se is known in the art such as signal processing or a trained neural network. The step of converting the input sound into the input signal and the another input sound into another input signal may consider the first distance between the first input transducer and the user's ear and/or the second distance between the second input transducer and the user's ear.

In some embodiments, the step of processing the input signals comprises improving each of the first part of the input signal, the second part of the input signal and the third part of the input signal to respectively obtain an improved first part of the input signal, an improved second part of the input signal and an improved third part of the input signal.

The improving the first part of the input signal may comprise enhancing such as speech enhancing the first part of the input signal by de-reverbing and de-noising the first part of the input signal. The improving the second part of the input signal may comprise enhancing such as speech enhancing the second part of the input signal by de-reverbing and de-noising the second part of the input signal. The improving the third part of the input signal may comprise enhancing such as speech enhancing the third part of the input signal by de-reverbing and de-noising the third part of the input signal.

In some embodiments, the step of adjusting the sidetone gain of the first part of the input signal comprises adjusting the sidetone gain of the improved first part of the input signal by the third component of the processing unit of the hearing device to obtain the output signal having an adjusted sidetone gain. This may in turn allow for providing an improved output signal having the adjusted sidetone gain e.g. an improved output signal with an improved signal to noise ratio (SNR).

In some embodiments, the step of processing the input signals further comprises applying a first model to the improved first part of the input signal to obtain the first processed input signal. In some embodiments, the step of processing the input signals further comprises applying a second model to the improved second part of the input signal to obtain the second processed input signal. The applying the first model may comprise applying a first mathematical model such as a mouth-to-ear transfer function to the improved first part of the input signal. The applying the second model may comprise applying a second mathematical model such as a hearing device microphone-to-ear transfer function to the improved second part of the input signal. The first model may consider the first distance between the receiving microphone e.g. the boom arm microphone and the user's ear, a shape of the user's head, ear canal, etc. The second model may consider the second distance between the receiving microphone e.g. the hearing device microphone and the user's ear, a shape of the user's head, ear canal, etc.

The step of processing the input signals may comprise improving each of the first part of the input signal, the second part of the input signal and the third part of the input signal and applying the first model to the improved first part of the input signal or applying the second model to the improved second part of the input signal.

The step of processing the input signals may comprise improving each of the first part of the input signal, the second part of the input signal and the third part of the input signal, applying the first model to the improved first part of the input signal and applying the second model to the improved second part of the input signal.

In some embodiments, the step of applying the model to the processed input signals comprises determining a level of the first processed input signal. In some embodiments, the step of applying the model to the processed input signals comprises comparing the level of the first processed input signal with a first threshold value, a second threshold value, a third threshold value, and a fourth threshold value to obtain the sidetone parameter. The threshold values may be obtained from conversions in different noise conditions and where the people are talking without being interrupted and when they are interrupted by people they are communicating with. The people may only be wearing a boom microphone, such that their ability of hearing themselves may not be affected. These conversations may then be passed through the model to compute the natural distributions and the thresholds may then based on these distributions.

The determining the level of the first processed input signal may comprise computing the level of the first processed input signal. The determining the level of the first processed input signal may comprise computing using the loudness model/masking. The determining the level of the first processed input signal may be performed by a sub-component of the third component. The comparing the level of the first processed input signal with the first threshold value, the second threshold value, the third threshold value, and the fourth threshold value may be performed by another sub-component of the third component. The step of applying allows for classifying/categorizing the level of the first processed input signal, thereby facilitating obtaining the sidetone parameter. By the term “level” is hereby meant perceived loudness. For instance, by the term “level of the first processed input signal” is hereby meant the perceived loudness of the user's voice. The first threshold value, the second threshold value, the third threshold value, and the fourth threshold value may relate to threshold values corresponding to four different levels of the loudness of the user's voice. The levels of the loudness of the user's voice may in turn depend on other people talking and/or the background noise

In some embodiments, the step of applying the model to the processed input signals comprises determining a level of the second processed input signal. In some embodiments, the step of applying the model to the processed input signals comprises comparing the level of the second processed input signal with a fifth threshold value, to obtain the sidetone parameter.

The determining the level of the second processed input signal may comprise computing the level of the second processed input signal. The determining the level of the second processed input signal may comprise computing using the loudness model/masking. The determining the level of the second processed input signal may be performed by yet another sub-component of the third component. The comparing the level of the second processed input signal with the fifth threshold value may be performed by yet another sub-component of the third component. Alternatively, the comparing the level of the second processed input signal with the fifth threshold value may be performed by the same component of the third component used for comparing the level of the first processed input signal with the first threshold value, the second threshold value, the third threshold value, and the fourth threshold value. The step of applying allows for classifying/categorizing the level of the second processed input signal, thereby facilitating obtaining the sidetone parameter. The fifth threshold value may relate to a threshold value corresponding to a level of the loudness of the background's sound. The step of applying allows for classifying/categorizing the level of the second processed input signal, thereby facilitating obtaining the sidetone parameter.

In some embodiments, the step of applying the model to the processed input signals comprises determining a level of the third processed input signal. In some embodiments, the step of applying the model to the processed input signals comprises comparing the level of the third processed input signal with a sixth threshold value to obtain the sidetone parameter.

The determining the level of the third processed input signal may comprise computing the level of the third processed input signal. The determining the level of the third processed input signal may comprise computing using the loudness model/masking. The determining the level of the third processed input signal may be performed by yet another sub-component of the third component. The comparing the level of the third processed input signal with the sixth threshold value may be performed by yet another sub-component of the third component. Alternatively, the comparing the level of the third processed input signal with the sixth threshold value may be performed by the same component of the third component used for comparing the level of the second processed input signal with the fifth threshold value. The step of applying allows for classifying/categorizing the level of the third processed input signal, thereby facilitating obtaining the sidetone parameter. The sixth threshold value may relate to a threshold value corresponding to a level of the loudness of the far-end voice. The step of applying allows for classifying/categorizing the level of the third processed input signal, thereby facilitating obtaining the sidetone parameter.

In some embodiments, the step of adjusting the sidetone gain of the improved first part of the input signal comprises increasing a sidetone gain of the first part of the input signal by a factor determined by a difference/ratio between the level of the first processed input signal and the first threshold value when the level of the first processed input signal is above the first threshold value, when the level of the second processed input signal is below the fifth threshold value, and when the level of the third processed input signal is below the sixth threshold value.

In some embodiments, the step of adjusting the sidetone gain of the improved first part of the input signal comprises increasing a sidetone gain of the improved first part of the input signal by a factor determined by a difference/ratio between the level of the first processed input signal and the first threshold value when the level of the first processed input signal is above the first threshold value, when the level of the second processed input signal is below the fifth threshold value, and when the level of the third processed input signal is below the sixth threshold value.

In some embodiments, the step of adjusting the sidetone gain of the improved first part of the input signal comprises increasing the sidetone gain of the first part of the input signal by a factor determined by a difference/ratio between the level of the first processed input signal and the second threshold value when the level of the first processed input signal is above the second threshold value, when the level of the second processed input signal is above the fifth threshold value, and when the level of the third processed input signal is below the sixth threshold value.

In some embodiments, the step of adjusting the sidetone gain of the improved first part of the input signal comprises increasing the sidetone gain of the improved first part of the input signal by a factor determined by a difference/ratio between the level of the first processed input signal and the second threshold value when the level of the first processed input signal is above the second threshold value, when the level of the second processed input signal is above the fifth threshold value, and when the level of the third processed input signal is below the sixth threshold value.

In some embodiments, the step of adjusting the sidetone gain of the improved first part of the input signal comprises increasing the sidetone gain of the first part of the input signal by a factor determined by a difference/ratio between the level of the first processed input signal and the third threshold value when the level of the first processed input signal is above the third threshold value, when the level of the second processed input signal is below the fifth threshold value, and when the level of the third processed input signal is above the sixth threshold value.

In some embodiments, the step of adjusting the sidetone gain of the improved first part of the input signal comprises increasing the sidetone gain of the improved first part of the input signal by a factor determined by a difference/ratio between the level of the first processed input signal and the third threshold value when the level of the first processed input signal is above the third threshold value, when the level of the second processed input signal is below the fifth threshold value, and when the level of the third processed input signal is above the sixth threshold value.

In some embodiments, the step of adjusting the sidetone gain of the improved first part of the input signal comprises increasing the sidetone gain of the first part of the input signal by a factor determined by a difference/ratio between the level of the first processed input signal and the fourth threshold value when the level of the first processed input signal is above the fourth threshold value, when the level of the second processed input signal is above the fifth threshold value, and when the level of the third processed input signal is above the sixth threshold value.

In some embodiments, the step of adjusting the sidetone gain of the improved first part of the input signal comprises increasing the sidetone gain of the improved first part of the input signal by a factor determined by a difference/ratio between the level of the first processed input signal and the fourth threshold value when the level of the first processed input signal is above the fourth threshold value, when the level of the second processed input signal is above the fifth threshold value, and when the level of the third processed input signal is above the sixth threshold value.

The sidetone gain may be increased by the factor. The factor may be in the range of 1 to 4, corresponding to 0 dB to 12 dB.

In some embodiments, the first threshold value may be in the range of 70 phon to 80 phon. In some embodiments, the second threshold value may be in the range of 75 phon to 85 phon. In some embodiments, the third threshold value may be in the range of 80 phon to 90 phon. In some embodiments, the fourth threshold value may be in the range of 85 phon to 95 phon. In some embodiments, the fifth threshold value may be up to 40 phon. In some embodiments, the sixth threshold value may be up to 40 phon.

The present invention relates to different aspects including the hearing device and the method described above and in the following, and corresponding device parts, each yielding one or more of the benefits and advantages described in connection with the first mentioned aspect, and each having one or more embodiments corresponding to the embodiments described in connection with the first mentioned aspect and/or disclosed in the appended claims.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1 schematically illustrates an exemplary hearing device 100.

FIGS. 2 and 3 schematically illustrate overview and detailed view of components of a hearing device 100, respectively.

FIG. 4 schematically illustrates steps of a method 200 of adjusting a sidetone gain in a hearing device 100.

FIG. 5 illustrates graphs corresponding to loudness of a user's voice at four different conditions a, b, c, and d.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

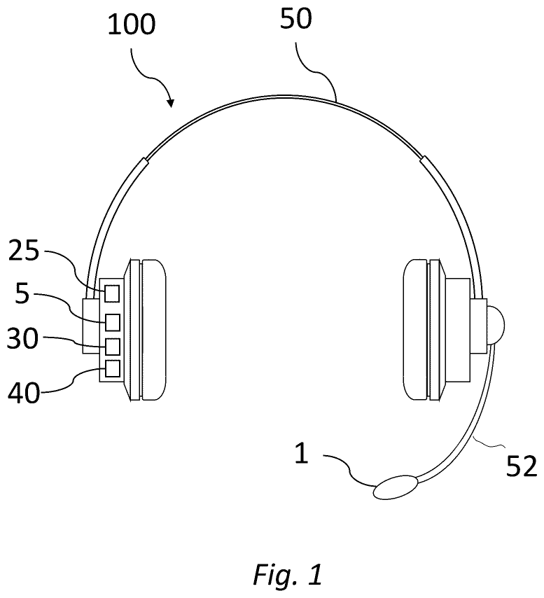

FIG. 1 schematically illustrates a hearing device 100. The hearing device 100 is configured to adjust a sidetone gain. The hearing device 100 may comprise a headband 50. The hearing device 100 may comprise a boom arm 52. The hearing device 100 comprises an input transducer 20. The input transducer 20 may comprise a plurality of input transducers 20. FIG. 1 shows that the input transducer 20 comprises a boom arm microphone 1 and a hearing device microphone 5. The hearing device 100 further comprises a transceiver 25. The hearing device further comprises a processing unit 30. The hearing device further comprises an output transducer 40.

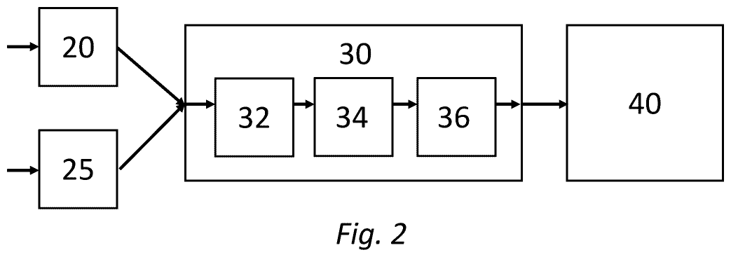

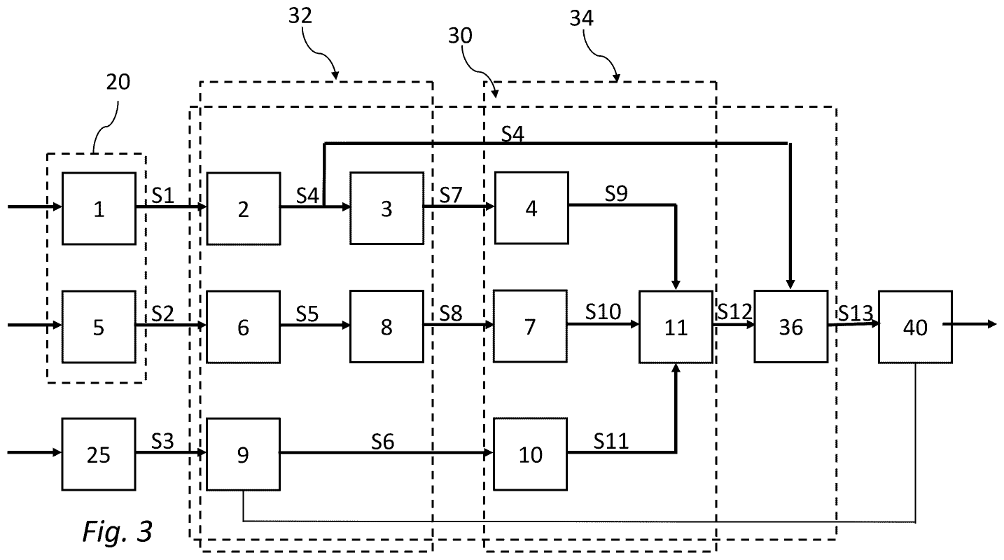

FIGS. 2 and 3 illustrate overview and detailed view of components of the hearing device 100, respectively. The input transducer 20 is configured to receive an input sound and to convert the input sound into an input signal S1, S2. The input transducer 20 may comprise a first input transducer 1. The first input transducer 1 may be configured to receive a first part of the input sound. The first input transducer 1 may be configured to convert the first part of the input sound into the first part of the input signal S1. The input transducer 20 may comprise a second input transducer 5. The second input transducer 5 may be configured to receive a second part of the input sound. The second input transducer 5 may be configured to convert the second part of the input sound into a second part of the input signal S2. The transceiver 25 is configured to receive another input sound and to convert the another input sound into another input signal S3. The processing unit 30 is arranged in connection with the input transducer 20 and the transceiver 25.

The processing unit 30 is configured to receive the input signal S1, S2 from the input transducer 20 and the another input signal S3 from the transceiver 25. The processing unit 30 may be configured to receive the first part of the input signal S1 from the first input transducer 1. The processing unit 30 may be configured to receive the second part of the input signal S2 from the second input transducer 5. The processing unit 30 is configured to provide an output signal S13 having an adjusted sidetone gain. The output transducer 40 is arranged in connection with the processing unit 30. The output transducer 40 is configured to receive the output signal S13 from the processing unit 30 and to convert the output signal S13 into an output sound.

FIGS. 2 and 3 illustrate that the processing unit 30 comprises a first component 32. The first component 32 may comprise a plurality of sub-components 2, 3, 6, 8, 9. The first component 32, 2, 3, 6, 8, 9 is arranged in connection with the input transducer 20 and the transceiver 25. The first component 32, 2, 3, 6, 8, 9 is configured to receive the input signals S1, S2, S3. The first component 32, 2, 3, 6, 8, 9 is configured to process the input signals S1, S2, S3 to obtain processed input signals S6, S7, S8. The first component 32, 2, 3, 6, 8, 9 may comprise a first sub-component 2 arranged in connection with the first input transducer 1. The first sub-component 2 may be configured to improve 232 the first part of the input signal S1. The processing unit 30 comprises a second component 34, 4, 7, 10, 11. The second component 34 may comprise a plurality of sub-components 4, 7, 10, 11. The second component 34, 4, 7, 10, 11 is arranged in connection with the first component 32, 2, 3, 6, 8, 9. The second component 34, 4, 7, 10, 11 is configured to receive the processed input signals S6, S7, S8. The second component 34, 4, 7, 10, 11 is configured to apply a model to the processed input signals S6, S7, S8 to determine a sidetone parameter S12. The processing unit 30 comprises third component 36. The third component 36 is arranged in connection with the second component 34, 4, 7, 10, 11. The third component 36 is configured to receive the sidetone parameter S12 from the second component 34, 4, 7, 10, 11. The third component 36 is configured to receive a first part of the input signal S1, corresponding to a user's voice, from the input transducer 20. The third component 36 is configured to adjust a sidetone gain of the first part of the input signal S1, based on the sidetone parameter S12, to obtain the output signal S13 having the adjusted sidetone gain. The third component 36 may be configured to receive the improved first part of the input signal S4. The third component 36 may be configured to adjust the sidetone gain of the improved first part of the input signal S4, based on the sidetone parameter S12, to obtain the output signal S13 having the adjusted sidetone gain.

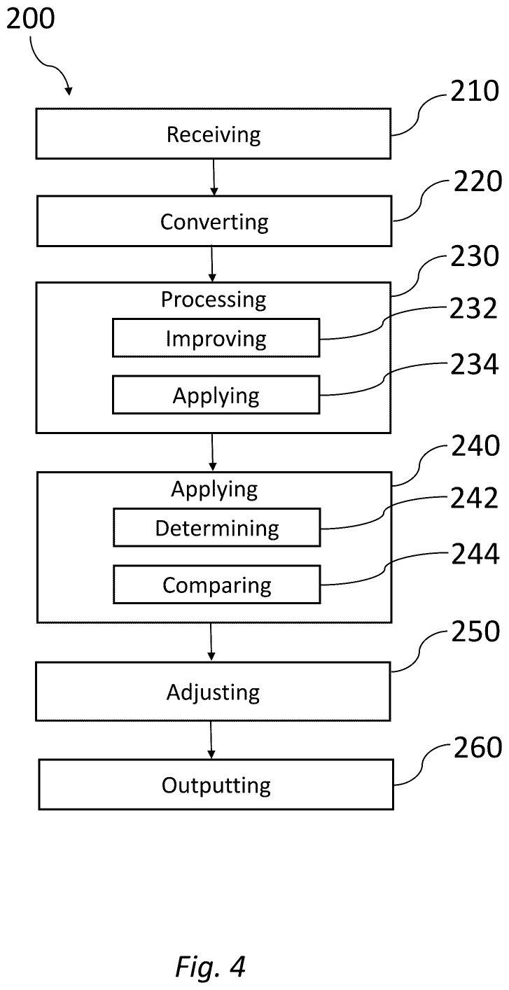

FIG. 4 schematically illustrates steps of a method 200 of adjusting a sidetone gain in a hearing device 100. The method 200 comprises the step of receiving 210 an input sound by an input transducer 20 of the hearing device 100 and another input sound by a transceiver 25 of the hearing device 100. The method 200 comprises the step of converting 220 the input sound into an input signal S1, S2 by the input transducer 20 of the hearing device 100 and the another input sound into another input signal S3 by the transceiver 25 of the hearing device 100. The method 200 comprises the step of processing 230 the input signals S1, S2, S3 by a first component 32, 2, 3, 6, 8, 9 of a processing unit 30 of the hearing device 100 to obtain processed input signals S6, S7, S8. The step of processing 230 the input signals S1, S2, S3 may comprise improving 232 each of the first part of the input signal S1, the second part of the input signal S2 and the third part of the input signal S3 to respectively obtain an improved first part of the input signal S4, an improved second part of the input signal S5 and an improved third part of the input signal S6. The step of processing 230 the input signals S1, S2, S3 may further comprise applying 234 a first model to the improved first part of the input signal S4 to obtain the first processed input signal S7. The step of processing 230 the input signals S1, S2, S3 may further comprise applying 234 a second model to the improved second part of the input signal S5 to obtain the second processed input signal S8.

The method 200 further comprises applying 240 a model to the processed input signals S6, S7, S8 by a second component 34, 4, 7, 10, 11 of the processing unit 30 of the hearing device 100 to determine a sidetone parameter S12. The step of applying 240 the model to the processed input signals S6, S7, S8 may comprise determining 242 a level S9 of the first processed input signal S7. The step of applying 240 the model to the processed input signals S6, S7, S8 may comprise comparing 244 the level S9 of the first processed input signal S7 with a first threshold value L1, a second threshold value L2, a third threshold value L3, and a fourth threshold value L4 to obtain the sidetone parameter S12. The step of applying 240 the model to the processed input signals S6, S7, S8 may comprise determining 242 a level S10 of the second processed input signal S8. The step of applying 240 the model to the processed input signals S6, S7, S8 may comprise comparing 244 the level S10 of the second processed input signal S8 with a fifth threshold value T1 to obtain the sidetone parameter S12. The step of applying 240 the model to the processed input signals S6, S7, S8 may comprise determining 242 a level S11 of the third processed input signal S6. The step of applying 240 the model to the processed input signals S6, S7, S8 may comprise comparing 244 the level S11 of the third processed input signal S6 with a sixth threshold value T2 to obtain the sidetone parameter S12. The method 200 further comprises the step of adjusting 250 a sidetone gain of the a first part of the input signal S1, based on the sidetone parameter S12, by a third component 36 of the processing unit 30 of the hearing device 100 to obtain an output signal S13 having an adjusted sidetone gain. The method 200 further comprises the step of outputting 260 the output signal S13 to an output transducer 40 of the hearing device 100.

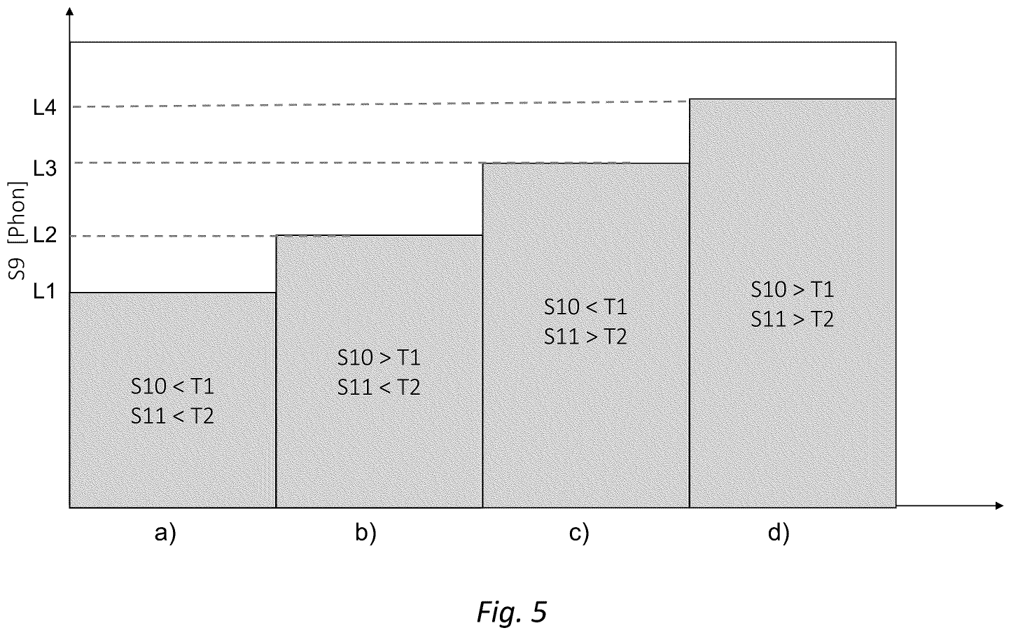

FIG. 5 illustrates graphs corresponding to loudness of a user's voice at four different conditions a, b, c, and d using the loudness model. The step of adjusting 250 the sidetone gain of the improved first part of the input signal S4 may comprise increasing a sidetone gain of the improved first part of the input signal S4 by a factor determined by a difference/ratio between the level S9 of the first processed input signal S7 and the first threshold value L1, when the level S9 of the first processed input signal S7 is above the first threshold value L1, when the level S10 of the second processed input signal S8 is below the fifth threshold value T1, and when the level S11 of the third processed input signal S6 is below the sixth threshold value T2. The factor may correspond to the sidetone parameter S12. The factor may be the sidetone parameter S12.

The step of adjusting 250 the sidetone gain of the improved first part of the input signal S4 may comprise increasing the sidetone gain of the improved first part of the input signal S4 by a factor determined by a difference/ratio between the level S9 of the first processed input signal S7 and the second threshold value L2, when the level S9 of the first processed input signal S7 is above the second threshold value L2, when the level S10 of the second processed input signal S8 is above the fifth threshold value T1, and when the level S11 of the third processed input signal S6 is below the sixth threshold value T2. The factor may correspond to the sidetone parameter S12. The factor may be the sidetone parameter S12.

The step of adjusting 250 the sidetone gain of the improved first part of the input signal S4 may comprise increasing the sidetone gain of the improved first part of the input signal S4 by a factor determined by a difference/ratio between the level S9 of the first processed input signal S7 and the third threshold value L3, when the level S9 of the first processed input signal S7 is above the third threshold value L3, when the level S10 of the second processed input signal S8 is below the fifth threshold value T1, and when the level S11 of the third processed input signal S6 is above the sixth threshold value T2. The factor may correspond to the sidetone parameter S12. The factor may be the sidetone parameter S12.

The step of adjusting 250 the sidetone gain of the improved first part of the input signal S4 may comprise increasing the sidetone gain of the improved first part of the input signal S4 by a factor determined by a difference/ratio between the level S9 of the first processed input signal S7 and the fourth threshold value L4 when the level S9 of the first processed input signal S7 is above the fourth threshold value L4, when the level S10 of the second processed input signal S8 is above the fifth threshold value T1, and when the level S11 of the third processed input signal S6 is above the sixth threshold value T2. The factor may correspond to the sidetone parameter S12. The factor may be the sidetone parameter S12.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly to be regarded in an illustrative rather than restrictive sense. The claimed invention is intended to cover all alternatives, modifications and equivalents.

### Items:

1. A hearing device (100) configured to adjust a sidetone gain, the hearing device comprising:
an input transducer (20) configured to receive an input sound and to convert the input sound into an input signal (S1, S2),
a transceiver (25) configured to receive another input sound and to convert the another input sound into another input signal (S3),
a processing unit (30) arranged in connection with the input transducer (20) and the transceiver (25), the processing unit (30) being configured to receive the input signal (S1, S2) from the input transducer (20) and the another input signal (S3) from the transceiver (25), and being configured to provide an output signal (S13) having an adjusted sidetone gain, and
an output transducer (40), arranged in connection with the processing unit (30), the output transducer (40) being configured to receive the output signal (S13) from the processing unit (30) and to convert the output signal (S13) into an output sound,

wherein the processing unit (30) comprises:
a first component (32, 2, 3, 6, 8, 9) arranged in connection with the input transducer (20) and the transceiver (25) and configured to receive the input signals (S1, S2, S3) and to process the input signals (S1, S2, S3) to obtain processed input signals (S6, S7, S8),
a second component (34, 4, 7, 10, 11) arranged in connection with the first component (32, 2, 3, 6, 8, 9) and configured to receive the processed input signals (S6, S7, S8) and to apply a model to the processed input signals (S6, S7, S8) to determine a sidetone parameter (S12),
a third component (36) arranged in connection with the second component (34, 4, 7, 10, 11) and configured to receive the sidetone parameter (S12) from the second component (34, 4, 7, 10, 11) and a first part of the input signal (S1), corresponding to a user's voice, from the input transducer (20) and configured to adjust a sidetone gain of the first part of the input signal (S1), based on the sidetone parameter (S12), to obtain the output signal (S13) having the adjusted sidetone gain.

2. The hearing device (100) according to item 1, wherein the input transducer (20) comprises a first input transducer (1) configured to receive a first part of the input sound and to convert the first part of the input sound into the first part of the input signal (S1), and a second input transducer (5) configured to receive a second part of the input sound and to convert the second part of the input sound into a second part of the input signal (S2), and wherein the processing unit (30) is configured to receive the first part of the input signal (S1) from the first input transducer (1), the second part of the input signal (S2) from the second input transducer (5), and the another input signal (S3) from the transceiver (25) and configured to provide the output signal (S13) having the adjusted sidetone gain.

3. The hearing device (100) according to item 2, wherein the first component (32, 2, 3, 6, 8, 9) comprises a first sub-component (2) arranged in connection with the first input transducer (1) and configured to improve (232) the first part of the input signal (S1), and wherein the third component (36) is configured to receive the improved first part of the input signal (S4) and adjust the sidetone gain of the improved first part of the input signal (S4), based on the sidetone parameter (S12), to obtain the output signal (S13) having the adjusted sidetone gain.

4. The hearing device (100) according to item 2, wherein the hearing device (100) comprises a headset configured to be arranged at a user's ear, wherein the first input transducer (1) is arranged at a first distance from the user's ear and the second input transducer (5) is arranged at a second distance from the user's ear.

5. The hearing device (100) according to item 4, wherein the first component (32) is configured to process the first input signal based on the first distance and the second input signal based on the second distance to obtain the processed input signal.

6. A method (200) of adjusting a sidetone gain in a hearing device (100), the method (200) comprising the steps of:
receiving (210) an input sound by an input transducer (20) of the hearing device (100) and another input sound by a transceiver (25) of the hearing device (100),
converting (220) the input sound into an input signal (S1, S2) by the input transducer (20) of the hearing device (100) and the another input sound into another input signal (S3) by the transceiver (25) of the hearing device (100),
processing (230) the input signals (S1, S2, S3) by a first component (32, 2, 3, 6, 8, 9) of a processing unit (30) of the hearing device (100) to obtain processed input signals (S6, S7, S8),
applying (240) a model to the processed input signals (S6, S7, S8) by a second component (34, 4, 7, 10, 11) of the processing unit (30) of the hearing device (100) to determine a sidetone parameter (S12),
adjusting (250) a sidetone gain of a first part of the input signal (S1), corresponding to a user's voice, based on the sidetone parameter (S12), by a third component (36) of the processing unit (30) of the hearing device (100) to obtain an output signal (S13) having an adjusted sidetone gain, and
outputting (260) the output signal (S13) to an output transducer (40) of the hearing device (100).

7. The method (200) according to item 6, wherein the step of converting (220) the input sound into the input signal (S1, S2) and the another input sound into another input signal (S3) comprises:
converting (220) a part of the input signal (S1, S2) corresponding to a user's voice into a first part of the input signal (S1),
converting (220) a part of the input signal (S1, S2) corresponding to a background sound into a second part of the input signal (S2),
converting (220) a part of the another input signal (S3) corresponding to a far-end voice into a third part of the input signal (S3).

8. The method (200) according to any of the items 6-7, wherein the step of processing (230) the input signals (S1, S2, S3) comprises:
improving (232) each of the first part of the input signal (S1), the second part of the input signal (S2) and the third part of the input signal (S3) to respectively obtain an improved first part of the input signal (S4), an improved second part of the input signal (S5) and an improved third part of the input signal (S6).

9. The method (200) according to item 8, wherein the step of adjusting the sidetone gain of the first part of the input signal (S1) comprises adjusting the sidetone gain of the improved first part of the input signal (S4) by the third component (36) of the processing unit (30) of the hearing device (100) to obtain the output signal (S13) having an adjusted sidetone gain.

10. The method (200) according to item 8 or 9, wherein the step of processing (230) the input signals (S1, S2, S3) further comprises:
applying (234) a first model to the improved first part of the input signal (S4) to obtain the first processed input signal (S7), and
applying (234) a second model to the improved second part of the input signal (S5) to obtain the second processed input signal (S8).

11. The method (200) according to item 10, wherein the step of applying (240) the model, optionally a loudness model, to the processed input signals (S6, S7, S8) comprises:
determining (242) a level (S9) of the first processed input signal (S7),
comparing (244) the level (S9) of the first processed input signal (S7) with a first threshold value (L1), a second threshold value (L2), a third threshold value (L3), and a fourth threshold value (L4) to obtain the sidetone parameter (S12).

12. The method (200) according to any of the items 10 or 11, wherein the step of applying (240) the model to the processed input signals (S6, S7, S8) comprises:
determining (242) a level (S10) of the second processed input signal (S8), and
comparing (244) the level (S10) of the second processed input signal (S8) with a fifth threshold value (T1) to obtain the sidetone parameter (S12).

13. The method (200) according to any of the items 10-12, wherein the step of applying (240) the model to the processed input signals (S6, S7, S8) comprises:
determining (242) a level (S11) of the third processed input signal (S6), and
comparing (244) the level (S11) of the third processed input signal (S6) with a sixth threshold value (T2) to obtain the sidetone parameter (S12).

14. The method (200) according to any of the items 9-13, wherein the step of adjusting (250) the sidetone gain of the improved first part of the input signal (S4) comprises:
increasing a sidetone gain of the improved first part of the input signal (S4) by a factor determined by a difference/ratio between the level (S9) of the first processed input signal (S7) and the first threshold value (L1), when the level (S9) of the first processed input signal (S7) is above the first threshold value (L1), when the level (S10) of the second processed input signal (S8) is below the fifth threshold value (T1), and when the level (S11) of the third processed input signal (S6) is below the sixth threshold value (T2).

15. The method according to any of the items 11-14, wherein the step of adjusting (250) the sidetone gain of the improved first part of the input signal (S4) comprises:
increasing the sidetone gain of the improved first part of the input signal (S4) by a factor determined by a difference/ratio between the level (S9) of the first processed input signal (S7) and the second threshold value (L2), when the level (S9) of the first processed input signal (S7) is above the second threshold value (L2), when the level (S10) of the second processed input signal (S8) is above the fifth threshold value (T1), and when the level (S11) of the third processed input signal (S6) is below the sixth threshold value (T2).

16. The method (200) according to any of the items 11-15, wherein the step of adjusting (250) the sidetone gain of the improved first part of the input signal (S4) comprises:
increasing the sidetone gain of the improved first part of the input signal (S4) by a factor determined by a difference/ratio between the level (S9) of the first processed input signal (S7) and the third threshold value (L3), when the level (S9) of the first processed input signal (S7) is above the third threshold value (L3), when the level (S10) of the second processed input signal (S8) is below the fifth threshold value (T1), and when the level (S11) of the third processed input signal (S6) is above the sixth threshold value (T2).

16. The method (200) according to any of the items 11-16, wherein the step of adjusting (250) the sidetone gain of the improved first part of the input signal (S4) comprises:
increasing the sidetone gain of the improved first part of the input signal (S4) by a factor determined by a difference/ratio between the level (S9) of the first processed input signal (S7) and the fourth threshold value (L4) when the level (S9) of the first processed input signal (S7) is above the fourth threshold value (L4), when the level (S10) of the second processed input signal (S8) is above the fifth threshold value (T1), and when the level (S11) of the third processed input signal (S6) is above the sixth threshold value (T2).

17. The method (200) according to any of the items 11-16, wherein
the first threshold value (L1) is in the range of 70 phon to 80 phon,
the second threshold value (L2) is in the range of 75 phon to 85 phon,
the third threshold value (L3) is in the range of 80 phon to 90 phon,
the fourth threshold value (L4) is in the range of 85 phon to 95 phon,
the fifth threshold value (T1) is up to 40 phon, and
the sixth threshold value (T2) is up to 40 phon.

### LIST OF REFERENCES

1 First input transducer
2 First sub-component of first component
5 Second input transducer
20 Input transducer
25 Transceiver
30 Processing unit
32 First component
34 Second component
36 Third component
40 Output transducer
52 Boom arm
100 Hearing device
200 Method of adjusting a sidetone level
210 Method step receiving
220 Method step converting
230 Method step processing
232 Method sub-step improving
234 Method sub-step applying
240 Method step applying
242 Method sub-step determining
244 Method sub-step comparing
250 Method step adjusting
260 Method step outputting
L, B, F level
L1 First threshold value
L2 Second threshold value
L3 Third threshold value
L4 Fourth threshold value
T1 Fifth threshold value
T2 Sixth threshold value
S1, S2, S3 Input signal
S6, S7, S8 Processed input signal
S9 Level of the first processed input signal S7
S10 Level of the second processed input signal S8
S11 Level of the third processed input signal S6
S12 Sidetone parameter
S13 Output signal

1. A hearing device configured to adjust a sidetone gain, the hearing device comprising:
an input transducer configured to receive an input sound and to convert the input sound into an input signal,
a transceiver configured to receive another input sound and to convert the another input sound into another input signal,
a processing unit arranged in connection with the input transducer and the transceiver, the processing unit being configured to receive the input signal from the input transducer and the another input signal from the transceiver, and being configured to provide an output signal having an adjusted sidetone gain, and
an output transducer, arranged in connection with the processing unit, the output transducer being configured to receive the output signal from the processing unit and to convert the output signal into an output sound,
wherein the processing unit comprises:
a first component arranged in connection with the input transducer and the transceiver and configured to receive the input signals and to process the input signals to obtain processed input signals,
a second component arranged in connection with the first component and configured to receive the processed input signals and to apply a model to the processed input signals to determine a sidetone parameter,
a third component arranged in connection with the second component and configured to receive the sidetone parameter from the second component and a first part of the input signal, corresponding to a user's voice, from the input transducer and configured to adjust a sidetone gain of the first part of the input signal, based on the sidetone parameter, to obtain the output signal having the adjusted sidetone gain.

2. The hearing device according to claim 1, wherein the input transducer comprises a first input transducer configured to receive a first part of the input sound and to convert the first part of the input sound into the first part of the input signal, and a second input transducer configured to receive a second part of the input sound and to convert the second part of the input sound into a second part of the input signal, and wherein the processing unit is configured to receive the first part of the input signal from the first input transducer, the second part of the input signal from the second input transducer, and the another input signal from the transceiver and configured to provide the output signal having the adjusted sidetone gain.

3. The hearing device according to claim 2, wherein the first component comprises a first sub-component arranged in connection with the first input transducer and configured to improve the first part of the input signal, and wherein the third component is configured to receive the improved first part of the input signal and adjust the sidetone gain of the improved first part of the input signal, based on the sidetone parameter, to obtain the output signal having the adjusted sidetone gain.

4. A method of adjusting a sidetone gain in a hearing device, the method comprising the steps of:
receiving an input sound by an input transducer of the hearing device and another input sound by a transceiver of the hearing device,
converting the input sound into an input signal by the input transducer of the hearing device and the another input sound into another input signal by the transceiver of the hearing device,
processing the input signals by a first component of a processing unit of the hearing device to obtain processed input signals,
applying a model to the processed input signals by a second component of the processing unit of the hearing device to determine a sidetone parameter,
adjusting a sidetone gain of a first part of the input signal, corresponding to a user's voice, based on the sidetone parameter, by a third component of the processing unit of the hearing device to obtain an output signal having an adjusted sidetone gain, and
outputting the output signal to an output transducer of the hearing device.

5. The method according to claim 4, wherein the step of converting the input sound into the input signal and the another input sound into another input signal comprises:
converting a part of the input signal corresponding to a user's voice into a first part of the input signal,
converting a part of the input signal corresponding to a background sound into a second part of the input signal,
converting a part of the another input signal corresponding to a far-end voice into a third part of the input signal.

6. The method according to claim 4, wherein the step of processing the input signals comprises:
improving each of the first part of the input signal, the second part of the input signal and the third part of the input signal to respectively obtain an improved first part of the input signal, an improved second part of the input signal and an improved third part of the input signal.

7. The method according to claim 6, wherein the step of adjusting the sidetone gain of the first part of the input signal comprises adjusting the sidetone gain of the improved first part of the input signal by the third component of the processing unit of the hearing device to obtain the output signal having an adjusted sidetone gain.

8. The method according to claim 6, wherein the step of processing the input signals further comprises:
applying a first model to the improved first part of the input signal to obtain the first processed input signal, and
applying a second model to the improved second part of the input signal to obtain the second processed input signal.

9. The method according to claim 8, wherein the step of applying the model, optionally a loudness model, to the processed input signals comprises:
determining a level of the first processed input signal,
comparing the level of the first processed input signal with a first threshold value, a second threshold value, a third threshold value, and a fourth threshold value to obtain the sidetone parameter.

10. The method according to claim 8, wherein the step of applying the model to the processed input signals comprises:
determining a level of the second processed input signal, and
comparing the level of the second processed input signal with a fifth threshold value to obtain the sidetone parameter.

11. The method according to claim 8, wherein the step of applying the model to the processed input signals comprises:
determining a level of the third processed input signal, and
comparing the level of the third processed input signal with a sixth threshold value to obtain the sidetone parameter.

12. The method according to claim 7, wherein the step of adjusting the sidetone gain of the improved first part of the input signal comprises:
increasing a sidetone gain of the improved first part of the input signal by a factor determined by a difference/ratio between the level of the first processed input signal and the first threshold value, when the level of the first processed input signal is above the first threshold value, when the level of the second processed input signal is below the fifth threshold value, and when the level of the third processed input signal is below the sixth threshold value.

13. The method according to claim 9, wherein the step of adjusting the sidetone gain of the improved first part of the input signal comprises:
increasing the sidetone gain of the improved first part of the input signal by a factor determined by a difference/ratio between the level of the first processed input signal and the second threshold value, when the level of the first processed input signal is above the second threshold value, when the level of the second processed input signal is above the fifth threshold value, and when the level of the third processed input signal is below the sixth threshold value.

14. The method according to claim 9, wherein the step of adjusting the sidetone gain of the improved first part of the input signal comprises:
increasing the sidetone gain of the improved first part of the input signal by a factor determined by a difference/ratio between the level of the first processed input signal (S7) and the third threshold value, when the level of the first processed input signal is above the third threshold value, when the level of the second processed input signal is below the fifth threshold value, and when the level of the third processed input signal is above the sixth threshold value.

15. The method according to claim 9, wherein the step of adjusting the sidetone gain of the improved first part of the input signal comprises:
increasing the sidetone gain of the improved first part of the input signal by a factor determined by a difference/ratio between the level of the first processed input signal (S7) and the fourth threshold value when the level of the first processed input signal is above the fourth threshold value, when the level of the second processed input signal is above the fifth threshold value, and when the level of the third processed input signal is above the sixth threshold value.
